(19) United States
(12) Patent Application Publication
(10) Pub. No.: US 2014/0344264 A1
(43) Pub. Date: Nov. 20, 2014

(54) SYSTEM AND METHOD FOR SEARCHING INFORMATION IN DATABASES

(71) Applicant: Dun Laoghaire Institute of Art, Design and Technololgy, County Dublin (IE)

(72) Inventor: Hilary Anne Kenna, Dublin (IE)

(21) Appl. No.: 13/896,938

(22) Filed: May 17, 2013

(30) Foreign Application Priority Data
May 17, 2013 (GB) GB1308974.3

(51) Int. Cl. G06F 17/30

(52) U.S. Cl. CPC G06F 17/30867
USPC 707/731

(57) ABSTRACT

A data processing system for searching information recorded in one or more databases and for generating one or more corresponding search results for presentation via a user interface is beneficially implemented such that the system includes computing hardware which is operable to execute one or more software products recorded on machine-readable data storage media; the system operates in a manner which reduces an overall computational effort at the one or more databases and reduces an amount of data exchange between the one or more databases and the user interface. The system is operable to enable a user to define, via the user interface, one or more categories into which search results are to be sorted after analysis thereof. Moreover, the system is operable to provide on the user interface supplementary information describing in greater detail the search results in response to user-interrogation of the one or more graphical objects.

The present disclosure relates to systems for searching information in databases, and more specifically to systems for acquiring and displaying search results on a user interface in a multidimensional manner. Moreover, the present disclosure is also concerned with software products recorded on non-transitory machine-readable data storage media, wherein such software products are executable upon computing hardware, to implement the methods of the disclosure.

### BACKGROUND

Standard library catalogue interfaces, eDiscovery applications, online retail websites and most generic search engines employ a text-based query for producing a text list of corresponding hits. The text list of hits is generally an unstructured text list, for example in a generally descending order of relevance, and a user has to cycle through many screens, namely pages, of results to find out pertinent hits. There is only limited visualization of such results and it is time consuming and difficult to find pertinent results. Such generic search engines include contemporary Google and Yahoo search engines; “Google” and “Yahoo” are registered trademarks.

To increase the visualization of relevant results, it is known for the search engines to be supplemented with a side bar which contains text facets, for example list of text headings, through which a query can be narrowed by using check boxes or drop down menus to select limiting criteria to refine the list of results. While this is an improvement, it still produces another list-based results display that needs to be browsed through page by page.

There are visualization techniques that seek to present the search results visually. However, they are often artificial or apply some form of interpretation of the data to present a derived visualization. For example, interpreting the data to create a non-structured landscape view has been employed. A problem encountered with this approach is that the visualisation must be interpreted in some way and often this is not easily done or intuitive to an average user. While it solves the problem of visualisation of entire search results derived from a search query, it does not solve the problem of helping the user find the most relevant results within the visualization of the entire search results.

One conventional visualization technique includes visualization of the results of a query by utilizing symbols whose appearance varies with a characteristic of the query, for example number of hits or number of pages per hit. The results are displayed in a grid form and a user may interact with the grid to generate a sub-query and to view a list of hits in that query. While a means for selecting a symbol within the grid to display further information about the sub-query is disclosed, the problem of finding relevant results remains unaddressed. The visualization technique also requires significant mnemonic processing on behalf of the user to retain the meaning of the symbols used in the data key that are necessary to understand the displayed visualisation.

In a published U.S. Pat. No. 5,636,350 (“Using symbols whose appearance varies to show characteristics of a result of a query”; inventor—Eick; Applicant—Lucent Technologies Inc.), there is described an apparatus for showing the results of a search query performed on a database by a database system. The apparatus includes a display generation means coupled to the database system for receiving and generating a display therefrom. Moreover, the apparatus includes a display production means coupled to the display generation means for receiving and generating the generated display. Furthermore, the apparatus employs an n-dimensional array wherein each dimension represents a set of attribute values, a set of first areas in the display, each first area corresponding to a sub-query which specifies a particular set of n attribute values specified in the query, a symbol of varying appearance which appears in an area of the first areas, the varying appearance operating to indicate a characteristic of results of the sub-query corresponding to the area.

In a published United States patent application no. 201210084328A1 (“Graphical user interface for a search query”; inventors—Ishikawa, Nitta and Tejima; Applicant—IBM), there is described generation of a search query to be issued to a document search engine which is supported by providing a graphical user interface (GUI) creation unit that generates a GUI for supporting generation of a search query. The GUI creation unit generates a query-node creation window that is a GUI window for generating a new search word to be connected to a search query by a logical operator. The query-node creation window includes a sample document preview area that displays a sample document, a facet list area that displays facets extracted from the sample document in list form, a query-node creation assist area to assist generation of the new search word, and a logical-operator selection icon to select a logical operator that connects the generated search word.

Aforementioned search results are generated in response to considerable computing effort, namely to find matches between one or more search terms and one or more documents or other types of media; data server facilities consume considerable energy when executing such searches. Known search tools result in users sending multiple search requests because search results are often presented to them in an unstructured and confusing format, namely in a text list and/or graphical format as found in the known technical art. Hence, there exists a need for a search engine and search interface that facilitates a user to find most relevant results during a search, without needing to repeat searches unnecessarily which result in additional energy dissipation in database services and similar searching related apparatus, as well as consuming additional communication network capacity, which is especially pertinent when wireless network coupled devices are employed for hosting GUI's. Moreover, there exists a need to address problems of searching large sets of data to find relevant results, thereby reducing time spent in browsing through multiple pages of the search results.

### SUMMARY

The present disclosure seeks to provide an improved system for searching information in databases, and a method for operating the same, wherein the improved system beneficially technically operates in a manner which reduces an overall computational effort at one or more databases for a given session, and reduces an amount of data exchange between the one or more databases and a user interface (UI) by delivering comprehensive search results; there is thereby achievable a reduction the number of calls to the one or more databases.

In a first aspect of the disclosure, there is provided a data processing system as claimed in appended claim 1: there is provided a data processing system for searching information recorded in one or more databases and for generating one or more corresponding search results for presentation via a user interface (UI) in a manner which reduces overall computational effort at the one or more databases, and reduces an amount of data exchange between the one or more databases and the user interface (UI), wherein the system includes computing hardware which is operable to execute one or more software products recorded on machine-readable data storage media, wherein:
(i) the system is operable to enable a user to define, via the user interface (UI), one or more categories into which search results are to be sorted after analysis thereof;
(ii) the system is operable to receive one or more search terms input by the user via the user interface (UI), and to process the one or more search terms to include information indicative of the one or more categories to generate a corresponding search target;
(iii) the system is operable to communicate the search target to a database searching arrangement for searching the one or more databases to generate search results corresponding to the search target;
(iv) the system is operable to process the search results to distribute them to their respective one or more categories, and then to present the one or more categories in corresponding one or more spatial regions of one or more display devices providing the user interface (UI), wherein the one or more search results are presented as one or more graphical objects organized within the one or more spatial regions of the user interface (UI); and
(iv) the system is operable to provide on the user interface (UI) supplementary information describing in greater detail the one or more search results in response to user-interrogation of the one or more graphical objects representative of the one or more search results.

The disclosure is of advantage in that distributing the search results into the one or more categories renders them more readily understood when viewed by the user, resulting in the user being less likely to repeat the search which reduces use of resources at the database searching arrangement and one or more databases, for example reduced power utilization and communication system bandwidth requirements.

The disclosure reduces total of communication traffic, thereby resulting in less stress on communication networks. This enables slow data communication networks potentially to be employed. For example, initial confidential trials of embodiments of the present disclosure have been found to reduce communication traffic substantially by an order of magnitude.

By “graphical objects” is meant to include both text and non-textual symbols.

Beneficially, using less resources at database searching arrangement and one or more databases corresponds to a technical effect of consuming less energy thereat, namely improves energy efficiency.

In accordance with an embodiment of the present disclosure, the categories correspond to one or more data types stored in the one or more databases. Further, the categories correspond to one or more encoding standards employed to generate data represented by the search results, wherein the encoding standards include at least one of: documents, images, videos, multimedia content, audio content, e-book.

In accordance with another embodiment of the present disclosure, the search results correspond to one or more e-commerce products and are presented as one or more graphical objects organized within an n-dimensional matrix on the user interface (UI); for example, the search results may be presented as one or more thumbnail graphical images on the user interface (UI). Moreover, the search results are optionally scrollable along one or more regions of the user interface (UI). The one or more regions of the user interface (UI) are optionally dynamically reconfigurable in size and/or position within the graphical interface in response to user-interrogation of the search results presented on the user interface (UI).

In accordance with yet another embodiment of the present disclosure, the system is further operable to collect metadata from the databases corresponding to the search results and employ corresponding metadata to generate the supplementary information and provide on the user interface (UI), supplementary information describing in greater detail the search results in response to user-interrogation of the graphical symbols representative of the search results.

In accordance with yet another embodiment of the present disclosure, the user interface (UI) is optionally implemented by using one or more touch-sensitive graphical display devices. The display devices employed to implement the user interface (UI) are optionally coupled to the one or more database via a wireless communication network.

In another aspect, embodiments of the present disclosure provide a method of operating the data processing system.

Embodiments of the present disclosure facilitate displaying the macro and micro view of the search results simultaneously in a way that can be easily understood and interpreted by an average user, as confirmed by practical confidential trials. The user may visualize the results of a query and interactively select a sub-query to be displayed in a subsequent visualization view. The successively detailed visualization of a series of sub-queries flows from the general to the specific naturally and intuitively. The user interface of the present disclosure includes explicit data keys, for example icons/text labels and so forth, making the visualization of results understandable to the user with literacy and/or accessibility issues.

Additional aspects, advantages, features and objects of the present disclosure would be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of an environment including a display device, a search engine, and one or more databases, that are suitable for practicing various implementations of the present disclosure;

FIG. 2 is an illustration of a data processing system, in accordance with the present disclosure;

FIG. 3 is an illustration of a query builder on a user interface, in accordance with the present disclosure;

FIG. 4a to FIG. 4f are exemplary illustrations of the query builder of FIG. 3, in accordance with the present disclosure;

FIG. 5a and FIG. 5b are illustrations of an alternative layout of the query builder, in accordance with the present disclosure;

FIG. 6a to FIG. 6c are illustrations of another alternative layout of the query builder incorporating a grid user interface, in accordance with the present disclosure;

FIG. 7a to FIG. 7d are illustrations of a user interface displaying the query builder and the search results, in accordance with the present disclosure;

FIG. 8 is an illustration of steps of a method of using the data processing system, in accordance with the present disclosure; and

FIGS. 9a and 9b are illustrations of a user interface showing ability to save a user session, in accordance with the present disclosure.

### DETAILED DESCRIPTION OF ILLUSTRATIVE EMBODIMENTS

The following detailed description elucidates embodiments of the disclosure and ways in which it can be implemented. Although the best mode of carrying out the disclosure has been disclosed, those in the art would recognize that other embodiments for carrying out or practicing the disclosure are also possible.

The present disclosure provides a data processing system for searching information recorded in one or more databases and for generating corresponding search results for presentation via a user interface (UI) in an n-dimensional graphical format; the searching is performed based upon a search target, wherein the search target includes search term information input by the user together with category information defining the n-dimensional graphical format of the user interface (UI). The system includes computing hardware which is operable to execute one or more software products recorded on non-transitory machine-readable data storage media. The system is operable to categorize the corresponding search results into one or more categories and present the one or more categories in corresponding one or more spatial regions of one or more display devices providing the user interface (UI). The search results are represented by one or more graphical symbols, and supplementary information is provided on the user interface (UI) that describes in greater detail the search results in response to user-interrogation of the graphical symbols representative of the search results.

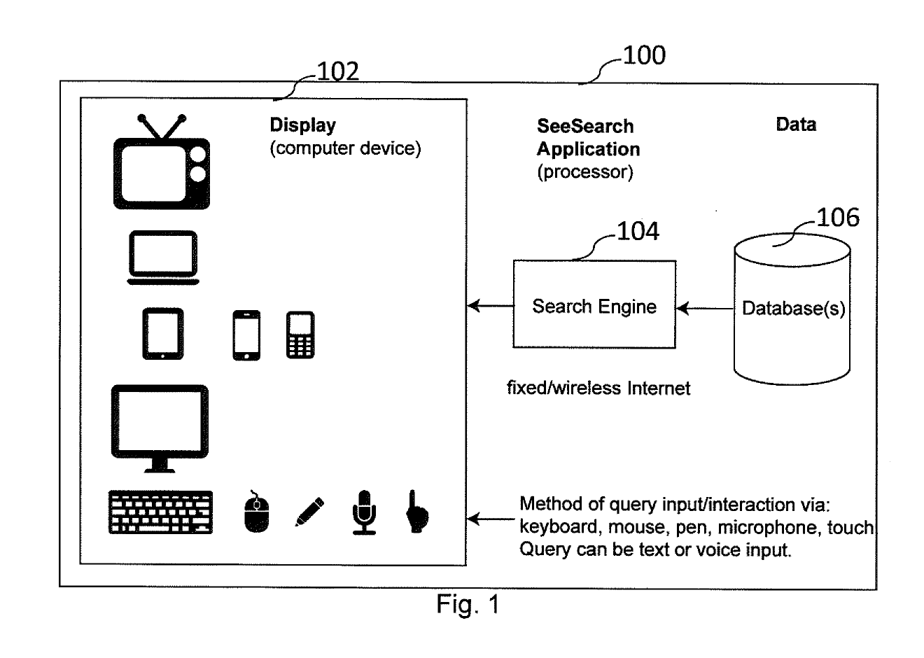

Referring now to the drawings, FIG. 1 is an illustration of an environment 100 including a display device 102, a search engine 104, and one or more databases 106, that are suitable for practicing various implementations of the present disclosure. The display device 102 is a computer/digital media device, and is optionally a touch-sensitive graphical display device; the display device 102 is implemented, for example, by using a desktop personal computer (PC), a lap-top computer, a phablet personal computer, a tablet computer, a mobile telephone, a smart phone, a personal digital assistance (PDA) or similar type of device. Beneficially, the display device 102 is wireless enabled, so that communication between the display device and the search engine 104 is implemented via a wireless communication network. In one embodiment, the search engine 104 is a software application installed on the display device 102, where the display device 102 is coupled to the databases 106 by way of a wireless communication network as aforementioned. In another embodiment, the search engine 104 includes computing hardware which is operable to execute one or more software products recorded on a non-transitory machine-readable data storage media. The search engine 104 is configured to search information recorded in one or more databases 106 and to generate one or more corresponding search results for presentation via a user interface (U I) on the display device 102.

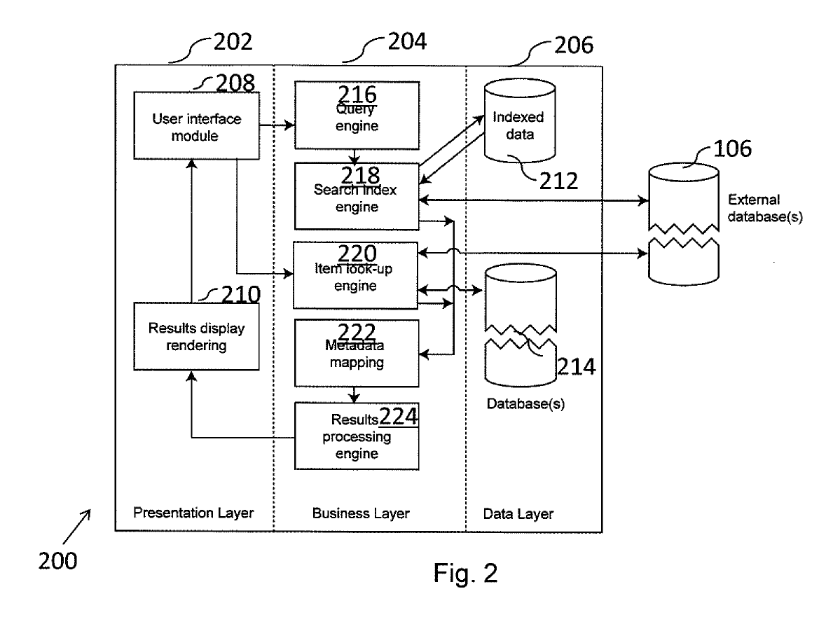

In FIG. 2, there is shown an illustration of a data processing system 200, which is an example of the search engine 104, in accordance with the present disclosure. The data processing system 200 is connected to the display device 102 and the one or more databases 106. In operation, the data processing system 200 generates a user interface (UI) on the display device 102, where the UI accepts a user query input, supplements the user query with additional information regarding one or more categories provided on the user interface (UI) to generate a search target, and the data processing system 200 operates to build queries based upon the search target in a format that can be used to query the one or more databases 106. The data processing system 200 then processes the search results obtained, based on the built query, and displays them on the UI in a graphical n-dimensional format, in relation to the aforesaid one or more categories.

In an embodiment of the present disclosure, the data processing system 200 presents the search results as graphical objects organized within an n-dimensional matrix on the UI, wherein n is an integer of value unity or greater; more optionally, n corresponds to a plurality. For example, the search results may be presented as thumbnail graphical images on the user interface (UI). Further, the UI includes regions that are dynamically reconfigurable in size and/or position in response to user-interrogation of the search results presented on the UI.

Furthermore, the data processing system 200 beneficially categorizes the search results into the one or more categories and presents the one or more categories in corresponding spatial regions of the UI. The one or more categories may correspond to one or more data types stored in the databases 106. The one or more categories may also correspond to one or more encoding standards employed to generate data represented by the search results. Examples of encoding standards, include, but are not limited to, documents, images, videos, multimedia content, audio content, and e-book.

The data processing system 200 may further provide on the UI, supplementary information describing in greater detail the search results in response to user-interrogation of the graphical symbols or objects representative of the search results. The supplementary information is generated based on metadata corresponding to the search results, where the data processing system 200 collects the metadata, corresponding to the search results, from the databases 106. For example, interrogating the graphical symbols or objects beneficially generates pop-up windows on the UI which are generated from meta-data received in the search results from the data processing system 200. Beneficially, when there are a large number of graphical symbols or objects, the graphical symbols or objects are represented in a scrollable manner which the user can flick, for example via finger swipe on a touch screen, to find a graphical symbol of interest representing a pertinent search result.

The data processing system 200 includes a presentation layer 202, a business layer 204, and a data layer 206. The presentation layer 202 includes a user interface module 208, and a results display rendering module 210. The data layer 206 includes an indexed data module 212, and an internal database 214. The business layer 204 includes a query engine 216, a search index engine 218, an item look-up engine 220, a metadata mapping module 222, and a results processing engine 224. One or more the layers 202, 204, 206 are optionally implemented in digital hardware, namely in a form of firmware.

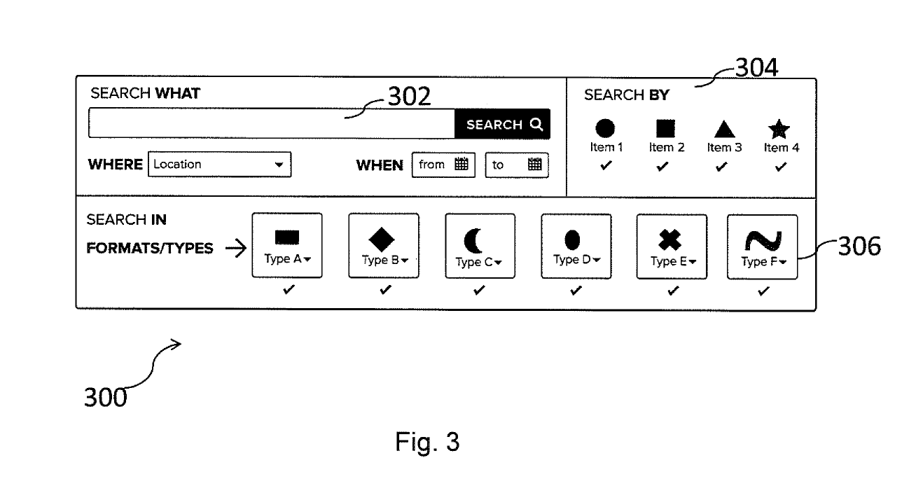

In FIG. 3, there is shown an illustration of a query builder 300 on a user interface (UI) generated by the data processing system 200 on the display device 102, in accordance with the present disclosure; the query builder 300 is operable to generate the aforesaid search target which is used for searching one or more databases. The query builder 300 includes a first region 302, that includes a text box for inputting a text query, for example search terms, and location and date filters for limiting the query by date and location, and a second region 304 having a first set of categories and a third region 306 having a second set of categories for narrowing down the query inputted in the first region 302. Optionally, by “category” is meant: type, grouping, nature, attribute, characteristic, age, media format, price, a metadata property, but not limited thereto.

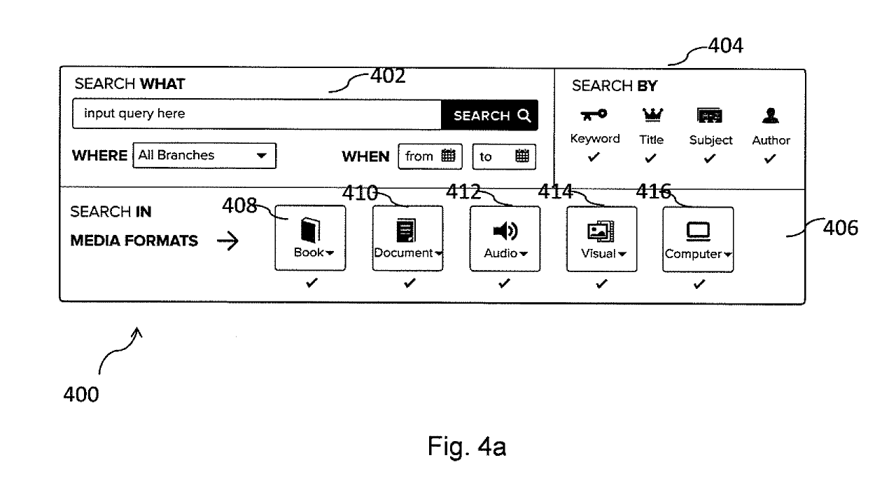

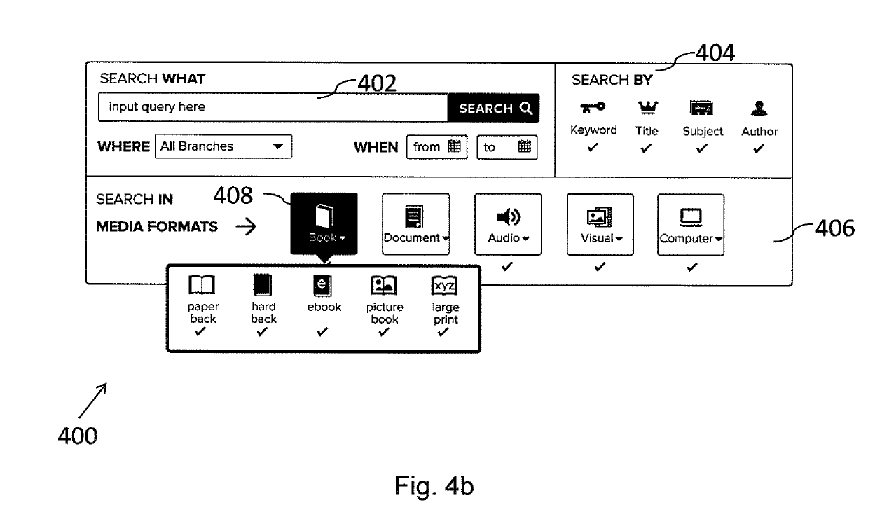

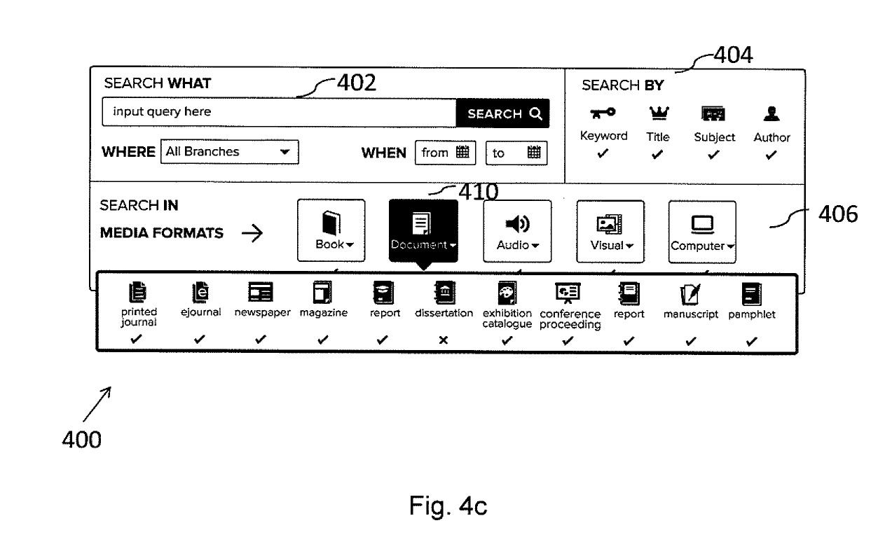

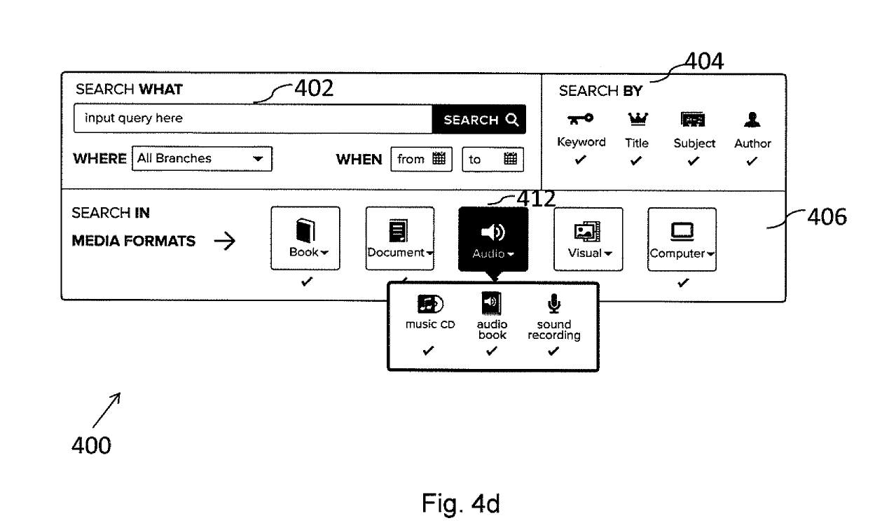

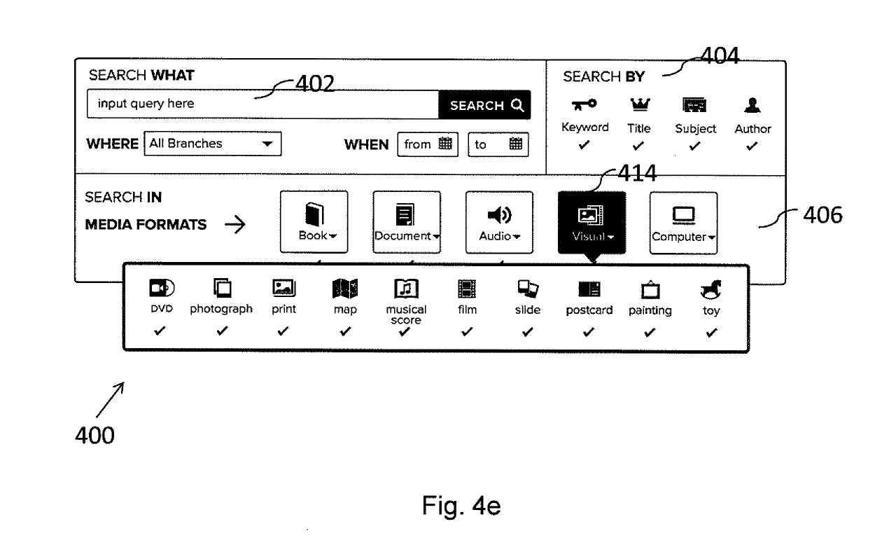

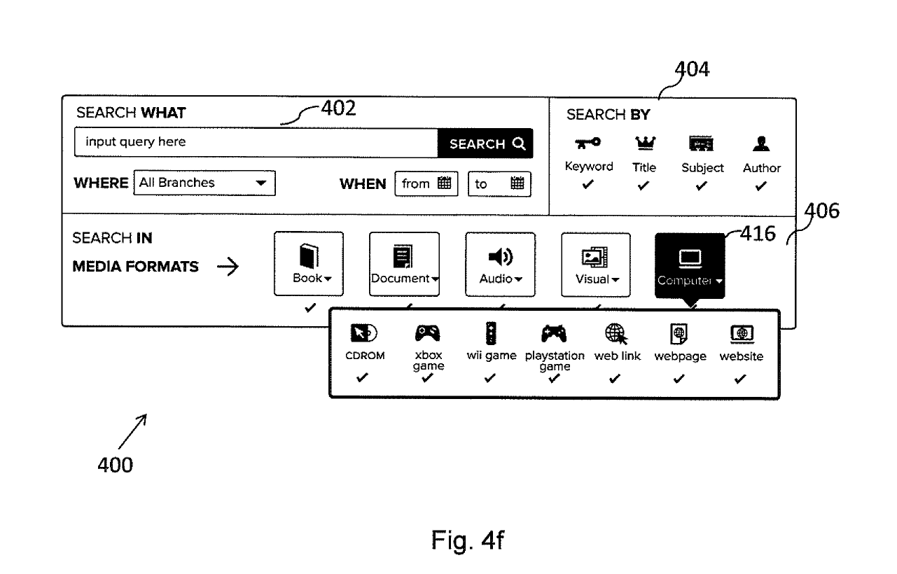

In FIG. 4a to FIG. 4f, there are shown exemplary illustrations of the query builder 400, which is an example of the query builder 300, in accordance with the present disclosure. The query builder 400 facilitates a user to query a library multimedia catalogue where there are different object or media types, for example book, CD, DVD, and so forth. The query builder 400 includes a first region 402, a second region 404 and a third region 406. The first region 402 includes a text box to input a text query, and location and date filters for limiting the query by date and location. The second region 404 includes a first set of filters corresponding to categories such as keyword, title, subject and author. The third region 406 includes a second set of filters corresponding to categories such as book 408, document 410, audio 412, visual 414, and computer 416 for limiting the query by media formats such as book, document, audio, visual and computer respectively. The first and second sets of filters are represented by corresponding graphical icons.

The query of a user may further be made specific by sub-categories of the categories book 408, document 410, audio 412, visual 414, and computer 416. For example, the book 408 includes sub-categories such as paper back, hard back, ebook, picture book, and large print. The document 410 includes sub-categories such as printed journal, e-journal, newspaper, magazine, report, dissertation, exhibition catalogue, conference proceeding, report, manuscript and pamphlet. The audio 412 includes sub-categories such as music CD, audio book and sound recording. The visual 414 includes sub-categories such as DVD, photograph, print, map, musical score, film, slide, postcard, painting and toy. The computer 416 includes sub-categories such as CDROM, xbox game, wii game, playstation game, web link, webpage, and website.

In FIG. 4a to FIG. 4f, there are shown further examples, which should not unduly limit the scope of the claims herein. One of ordinary skill in the art would recognize many variations, alternatives, and modifications of embodiments herein.

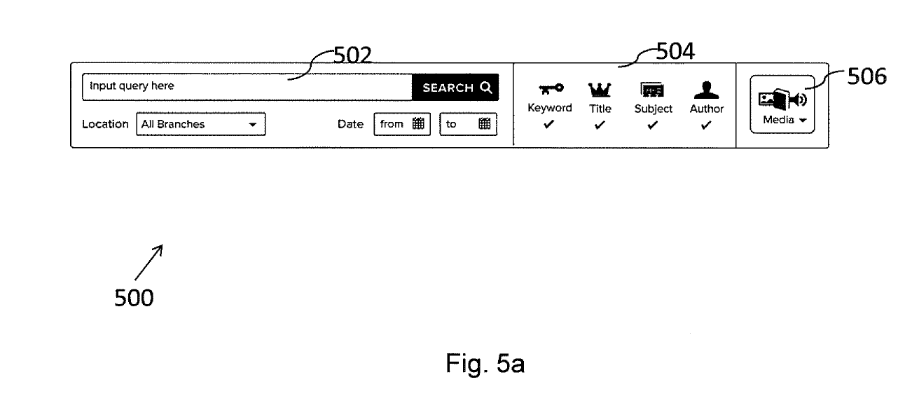

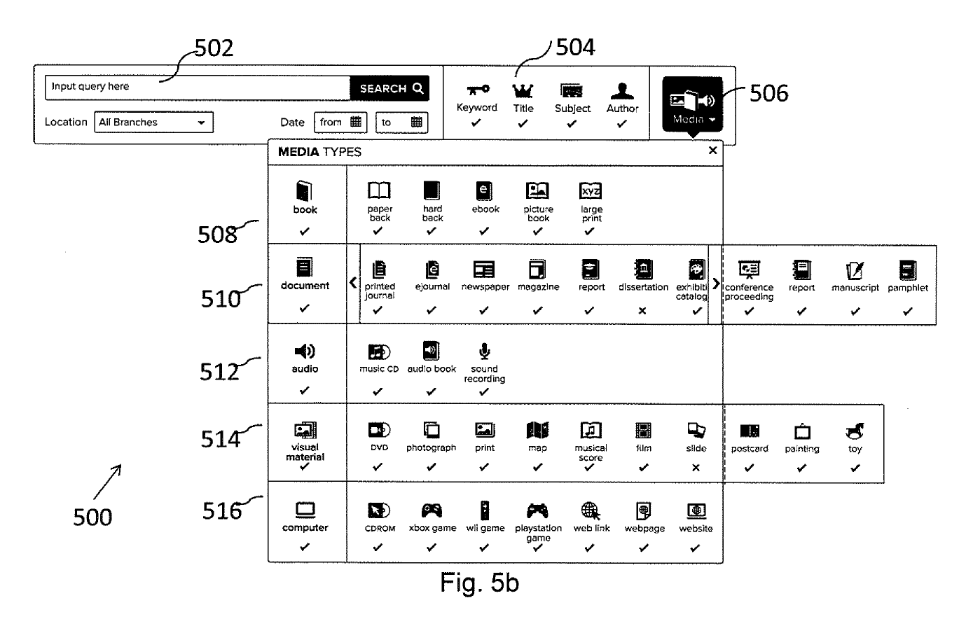

In FIG. 5a to FIG. 5b, there are shown illustrations of a query builder 500 which is an alternative implementation of the query builder 400, in accordance with the present disclosure. The query builder 500 occupies relatively less area on the UI as compared to the query builder 400. The query builder 500 includes a first region 502, a second region 504 and a third region 506. The first region 502 includes a text box to input a text query, and location and date filters for limiting the query by date and location. The second region 504 includes a first set of filters corresponding to categories such as keyword, title, subject and author. The third region 506 displays categories and sub-categories corresponding to media formats such as book 508, document 510, audio 512, visual 514, and computer 516 on user interrogation of the third region 506, when a user clicks on the third region 506.

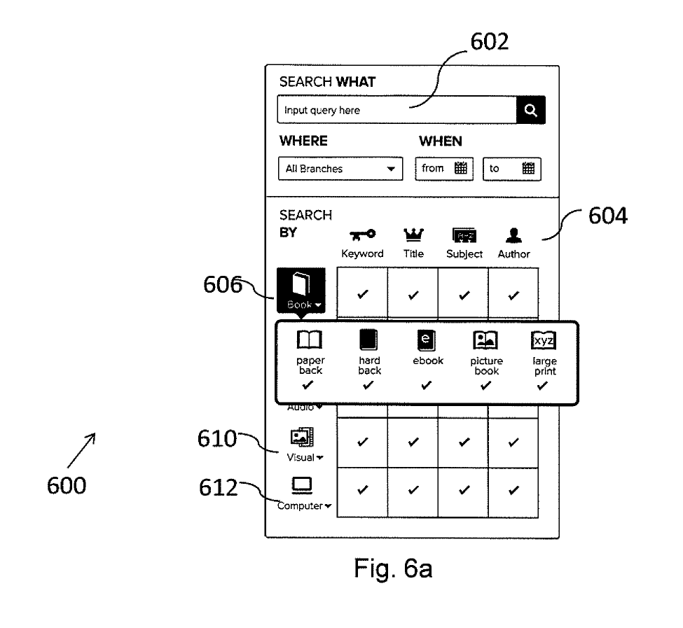

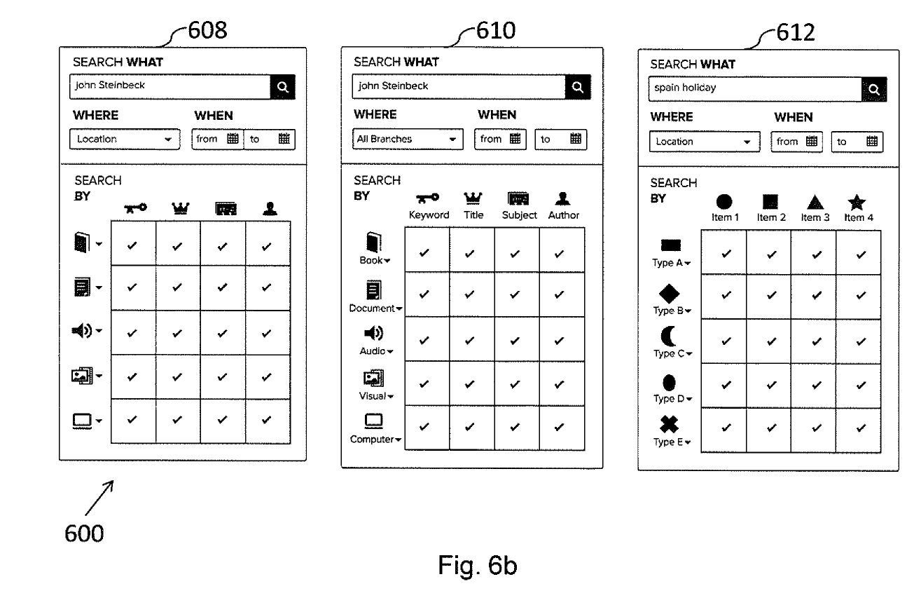

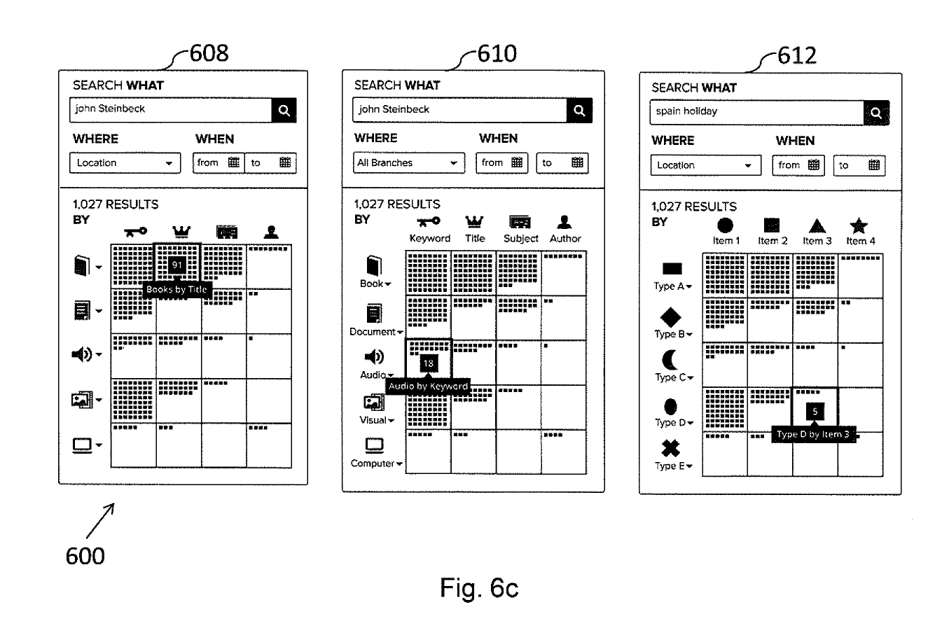

In FIG. 6a to FIG. 6c, there are shown illustrations of a query builder 600 incorporating a matrix user interface, which is an alternative implementation of the query builder 400, in accordance with the present disclosure. The query builder 600 includes a first region 602, and a second region 604. The first region 602 includes a text box to input a text query, and location and date filters for limiting the query by date and location. The second region 604 includes a first set of filters corresponding to categories such as keyword, title, subject and author, and a second set of filters corresponding to categories and sub-categories corresponding to media formats such as book 606, document 608, audio 610, visual 612, and computer 614. The second region 604 facilitates a user to select a combination of first and second set of filters.

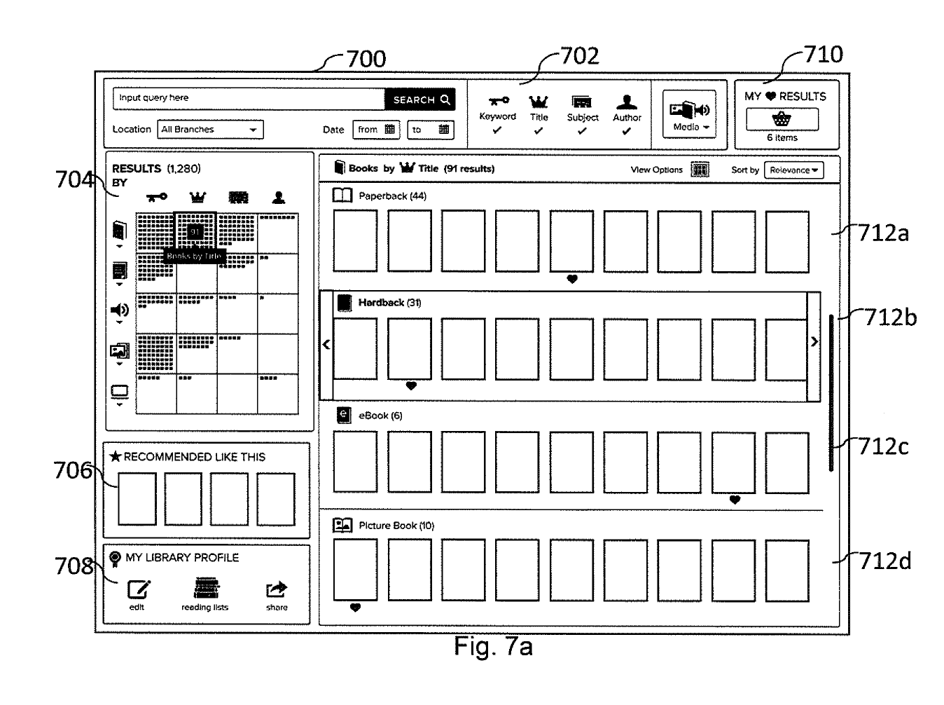

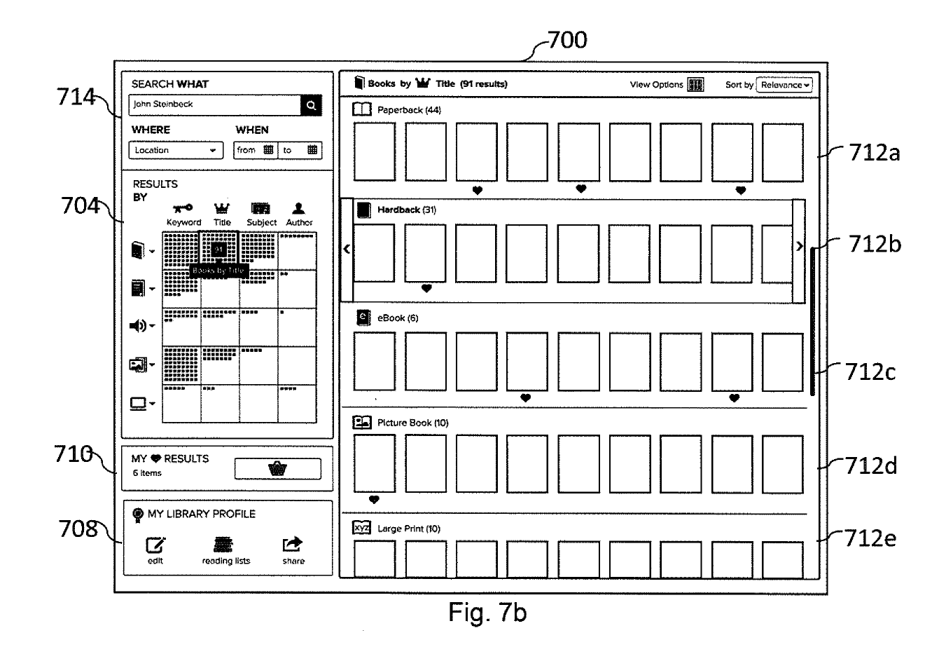

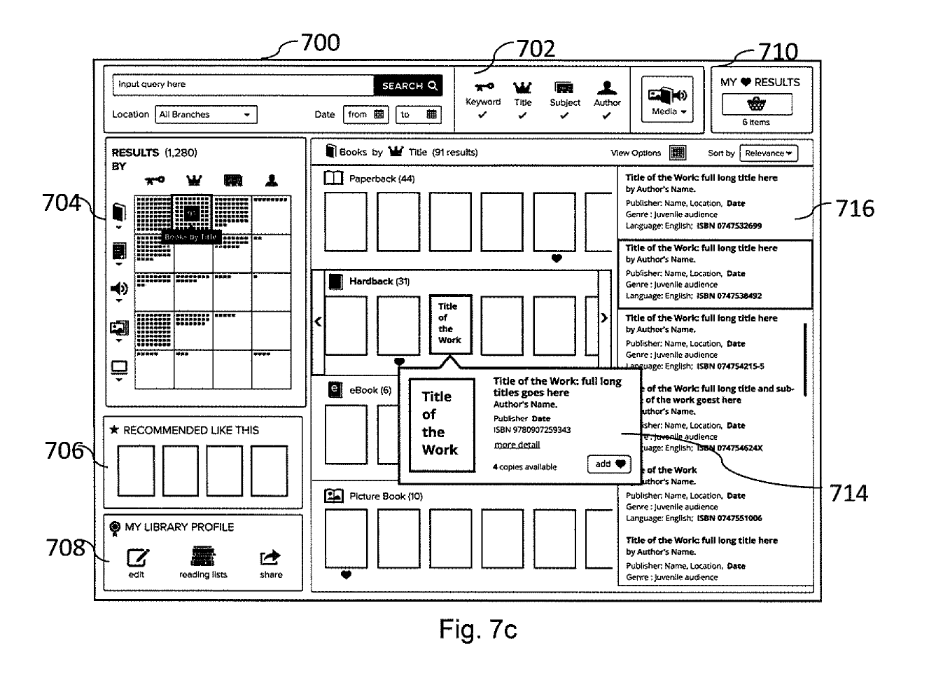

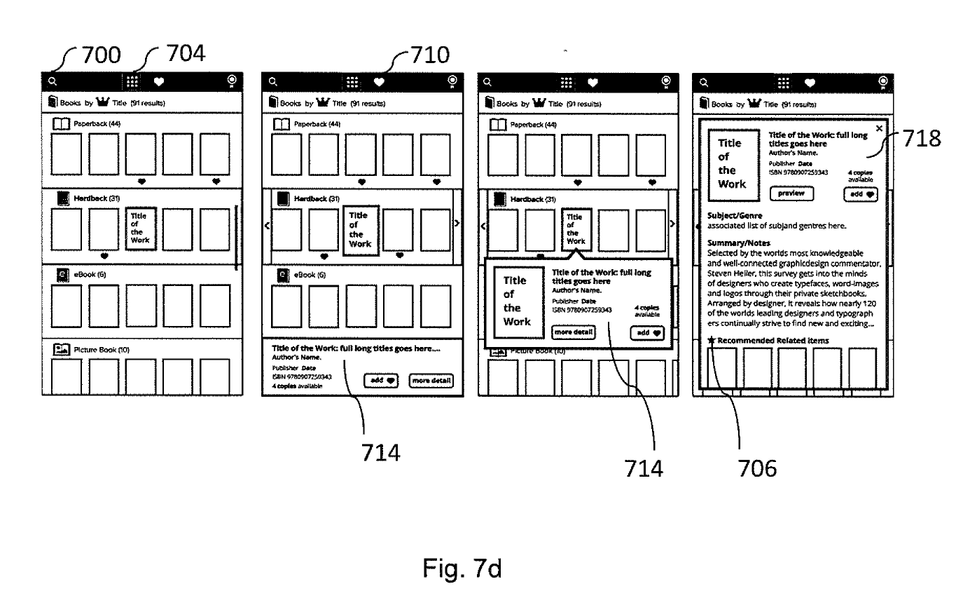

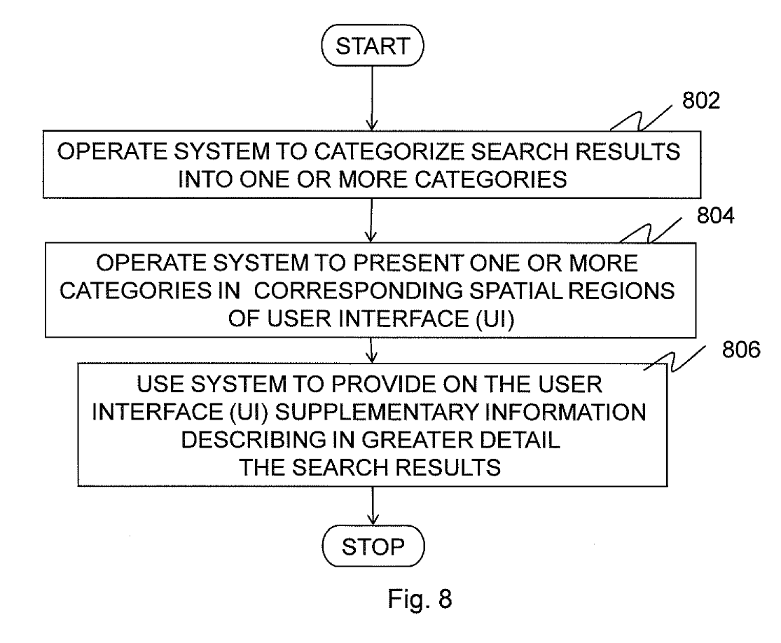

In FIG. 7a to FIG. 7d, there are shown illustrations of a user interface displaying the query builder and the search results, in accordance with the present disclosure. In FIG. 7c, a presentation field of the user interface (UI) is denoted by 700, and a left-hand region 704 illustrates in operation results identified in respect of one or more categories. The left-hand region 704 is, as shown, organized in a matrix or array manner, and includes potentially multidimensional results. A graphical symbol or object, for example a small rectangle, circle or dot, in each sector of the matrix represents an identified search result. By moving a search device, for example a computer mouse or touching an object on a touch screen, over sectors of the matrix, corresponding search results are presented in a central region, for example in a form of horizontally-scrollable graphical symbols, which can be interrogated to present supplementary results, derived from metadata, for example in a form of a pop-up window 714 as illustrated. In a right-hand region 716, there are shown textual results corresponding to the search results presented by graphical symbols, for example by thumbnails, in the central region. When the user clicks a pointing device on a given graphical symbol on the central region, a corresponding textual search result in the right-hand region 716 is brought into a field of view of the user; in a similar manner, when the user clicks a pointing device on a given textual search result in the right-hand region, a corresponding graphical symbol in the central field is scrolled into a field of view of the user. Such a manner of interaction enables the user to navigate highly efficiently through the search results, with less temptation to cause a further search to be executed, thereby economizing on searching resources and reducing corresponding energy dissipation in searching hardware and database hardware. Moreover, the present field optionally includes one or more additional regions as follows: recommended search results 706, my library profile 708, my results basket 710, search bar 702. Although FIG. 7c is an illustrative embodiment, it will be appreciated that the mutual spatial disposition of the regions within the presentation field can be varied, for example dynamically, to suit user preferences.

In FIG. 7a to FIG. 7d, there are provide broad views of hits in each category so that the user can narrow down his/her selections progressively until he/she finds the most relevant results. The user enters a query in the query builder area of the user interface (UI). A software product executing upon computing hardware generates a grid, matrix or array visualisation of the results with object or media categories along one axis and another associated dimension of the data along another axis. The number and colour of the dots, or substantially similar symbols thereto, in the grid, matrix or array indicate the number of hits in each set of categories. The user clicks on a grid, matrix or array location to select hits in that category. A second area of the UI displays the results of the selection in a categorized list where the vertical access is media type and the horizontal axis shows thumbnails of individual entries in each category. The user selects an element from the list and a third portion of the UI displays all results from this element in list format. The results may be ranked by relevance, date or other sorting criteria, for example alphabetic, and so forth.

The diagram illustrates options for different views and splits the visual list 712 to include a text list 716, for example thumbnail images and text list side-by-side. These are dynamically linked to each other as aforementioned. Selection of an item in either the visual list 712 or the text list 716 highlights in both and may also dynamically scroll either list to display the item. Items in the visual list 712 are displayed by sub categories 712 a to e, relevance and then date, namely most recent first, items in the text list 716 are displayed by relevancy. Default sort order is relevancy, but can also be date. The selected item in the visual list 712 invokes a pop over display bubble 714 which shows a larger image and more information about the selected result as aforementioned, for example based upon metadata returned in response to submitting the search target.

Results grid, matrix or array: the disclosure displays of the relevant returned results to the query sorted in the results matrix 704 in tiles that show 3-dimentions, namely n=3, of the data example, quantity of item by type, for example ninety one books by title. The results matrix provides a macro picture of all search results and remains on the display at all times, thereby enabling the user to see, and thereby appreciate, all results which can be further explored via other components of the interface (UI). The visualization used here is a generic matrix display that shows iconic representation in abstract blocks via tiles on the matrix. The combined effect is a visualization type called small multiples that enables the user to see at a glance the quantitative and qualitative spread of results to their query in a single visualization. Each tile of the grid is mini visualization of results to a sub query within the query. Optionally, logarithmic graphical presentation of search results is provided in the field 704 when there are a very large number of search results to be presented, whereas a linear geometrical presentation of search results is more usually employed when there are fewer search results to be presented.

Visual lists 712 and one or more pop-up bubbles 714, similarly pop-over bubbles, are also provided via the user interface (UI) as aforementioned.

The visual list 712 shows a further structured display of a sub-group of the results 712 a to e selected on the results grid, wherein a selected tile is highlighted. The visual list 712 is a structured visualization of the sub-categories 712 a to e within a sub-query of results selected on the results matrix 704. The visual list 712 presents a subset of relevant associated results with the most relevant result automatically highlighted. This enables the user to see the most relevant result presented in context to the overall results set. The visual list 712 presents results visually as images sorted into rows of different sub-categories. The horizontal image lists 712a to e in each row are side scrolling and can hold vast quantities in reserve only displaying a portion relevant to the user's selection and based on the size of the screen display device.

Selecting an item in the visual list 712 presents a pop-over bubble 714 which displays a micro view with more details about a single result via a larger image and more information about the selected item. It also enables the user to click to see a full screen modal window 718 with full details about item as stored in the database or to add the selected result to a list of favourite results 710 which they can save, export 909 and 900 and refer to during their search session or during a later session.

Visual 712 and text list combined display is provided via the user interface (UI), as aforementioned.

The split view that combines the visual list 712 and the text list 716 facilitates the user with a fast and easy display where the user can both browse visually through a sub-set of results 712a to e from the main query and/or to scroll through a text-based list 716 which shows more specificity of results. The combined displays that are dynamically mutually linked to each, enabling the user to switch seamlessly between each type of viewing the results of their query-example visually browsing and scanning reading. The display therefore suits a broader set of user preferences and learning styles in a single display simultaneously. Inclusion of the text-based lists 716 enables the user to feel rapidly more acquainted with the user interface, when the user is more accustomed to known conventional search browsers providing only text-based lists 716 of search results.

In general, this disclosure is designed to address the problem of presenting a large set of search results to a query in a display that is easier for users to understand and use. The main advantages thereby provided are:

(a) Simultaneous visual display of macro view of all search results; and

(b) Structured view of relevant sub-sets and micro view showing details of as single result.

By such an approach, a total number of user queries are sent to databases, thereby resulting in less data traffic in communication networks and also less power dissipation in database hardware, for example data servers. Such reduction in traffic has been proven during confidential trial use of the disclosure.

All of these views are displayed on a screen simultaneous, negating a need for multiple researching and paging/jumping forward and back through pages of results. Such presentation is more helpful to the user, thereby discouraging the user to execute further searches of databases for seeking results, thereby economizing on database searching resources.

The nature and combination of the visualizations used in this disclosure are not impressionistic, but represent structure and do not require significant cognitive or mnemonic processing on the users behalf to understand what they represent and how to further query them interactively. In effect, the disclosure enables users a much faster and easier to use technique for querying a database where they can discover a larger and broader range of results relevant to their query in a single query. For libraries and such, it means users can discover the complete range of resources available, for example books, articles, dvds, games, and so forth, relevant to their query, namely, it can be subject matter queried, about its, associated with it, by specific author, and so forth, in the collection in single search. This disclosure facilitates both search, namely finding a specific thing, and discovery, namely finding out about a specific thing and thing related to it. Initial testing with the current embodiment of the disclosure indicates that this display is advantageous for users with text literacy issues. The disclosure has a direct technical effect of saving database searching results, which provides benefits of energy savings and less database searching apparatus being required, namely represents an increase in system operating efficiency.

This disclosure is a technique for visualizing the results of a query and interactively selecting a sub-query to display in a subsequent visualization. This can be executed successively with each subsequent visualization providing more relevant information and in a visualization form that is appropriate to the sub-query. By using this technique, the results can be presented in preferably one screen, namely page, but in any event a small number of screens, namely pages, which allow the user to view visualizations of increasing detail and relevance in the query and to interactively select sub-queries of increasing detail and relevance from the visualizations.

The user interface (UI) optionally provides one or more data filtering features as listed in Table 1.

TABLE 1
Additional features provided by embodiments of the disclosure

Subsequent visualisations methods are different for the UI
Visualisation methods can be changed via the UI
Visualisation methods can be selected by the user via the UI
Visualisation method is selected according to data characteristics, i.e.
automatically data-driven data-filtering are implemented via hardware and/
or software
Selection of visualisation technique is automatic
Method of selection is related to relevance of results
Visualisation is an n-dimensional grid via the UI
Visualisation consists of thumbnails images via the UI
Visualisation is a list via the UI
List is sorted by relevance via the UI
Visualisations are presented to fit on a display of the UI
Visualisations are of different sizes depending on focus employed when
searching databases
Visualisations are stacked on the UI
Visualisations are on pages via the UI
Can move through pages using touch screen
Database is bibliographic information relating to multimedia items
Database is product information for an e-commerce application

When searching databases, various approaches can be adopted in embodiments of the disclosure. A solution to provide improved database searching is achieved by employing an aforementioned technique for displaying query results where the results of a query are displayed visually and a user selects a region of the visualization corresponding to a sub-query and the sub-query results are displayed in more detail in a subsequent visualization.

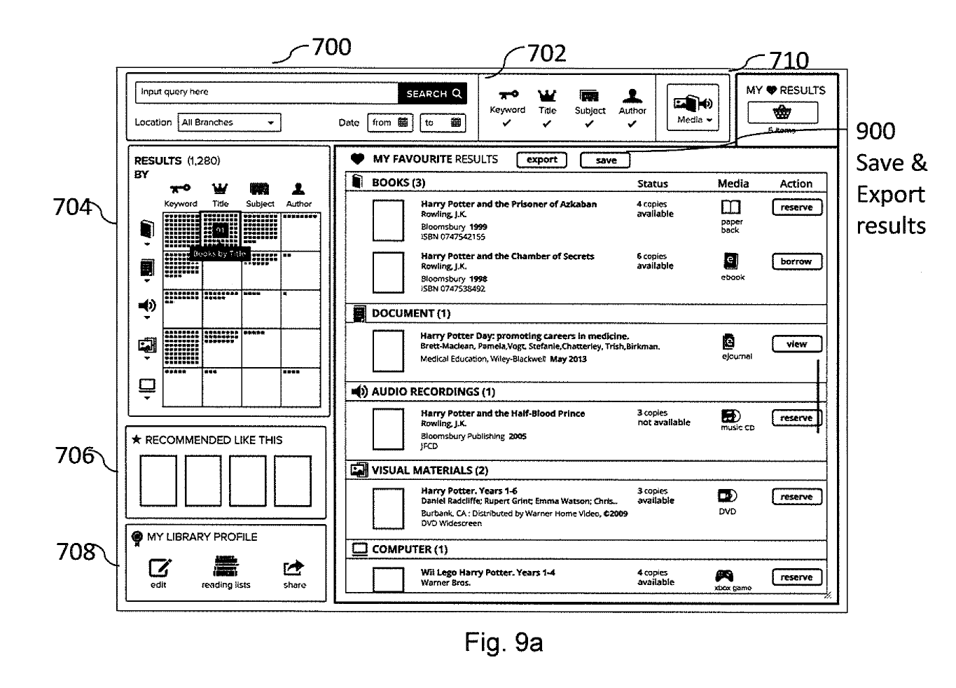

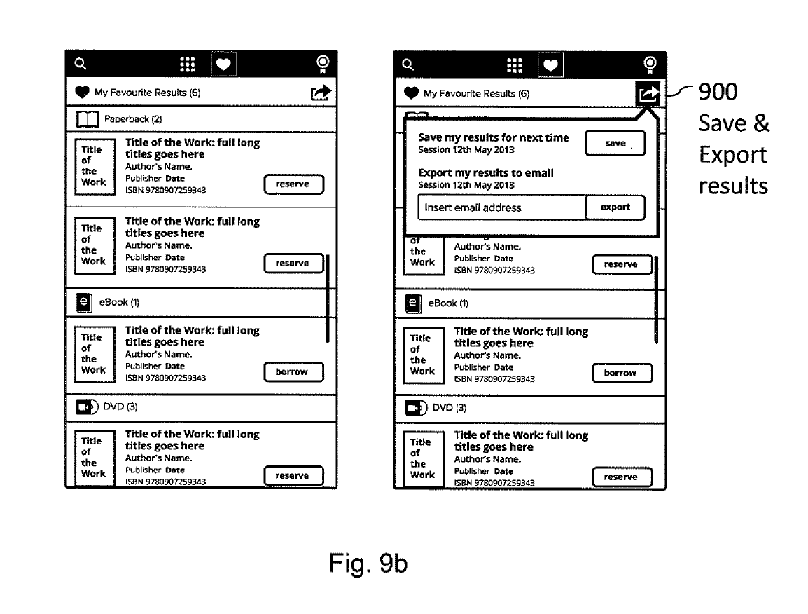

In FIG. 9a, a presentation field of the user interface (UI) is denoted by 900, and a left-hand region 904 illustrates in operation results identified in respect of one or more categories. The left-hand region 904 is, as shown, organized in a matrix or array manner, and includes potentially multidimensional results. In the right hand region, 910 is, as shown, provided to view saved results. A graphical symbol or object, for example a basket, represents saved results. By selecting the basket using a search device, for example a computer mouse or touching an object on a touch screen, saved search results are presented in a central region, for example in a form of horizontally-scrollable graphical symbols, which can be saved or export by selecting an icon or button 900, as shown, on desktop and mobile version of the user interface. Moreover, the present field optionally includes one or more additional regions as follows: recommended search results 906, my library profile 908, search bar 902. Although FIG. 9b is an illustrative embodiment of the user interface on mobile devices showing my favourite results, it will be appreciated that the icon and button used to enable this functionality can be varied to suit user preferences.

The UI also permits interactive selection of a subset of a query to generate a sub-query that is visualized and updated based on the selection.

In FIG. 5, which is merely an example, should not unduly limit the scope of the claims herein. One of ordinary skill in the art would recognize many variations, alternatives, and modifications of embodiments herein.

Modifications to embodiments of the disclosure described in the foregoing are possible without departing from the scope of the disclosure as defined by the accompanying claims. E.g. the embodiments could be used in cloud based applications and/or devices could have a projection style functionality allowing the invention to be used without a hardware display. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A data processing system for searching information recorded in one or more databases and for generating one or more corresponding search results for presentation via a user interface (UI) in a manner which reduces an overall computational effort at the one or more databases and reduces an amount of data exchange between the one or more databases and the user interface (UI), wherein the system includes computing hardware which is operable to execute one or more software products recorded on machine-readable data storage media, wherein:
(i) the system is operable to enable a user to define, via the user interface (UI), one or more categories into which search results are to be sorted after analysis thereof;
(ii) the system is operable to receive one or more search terms input by the user via the user interface (UI), and to process the one or more search terms to include information indicative of the one or more categories to generate a corresponding search target;
(iii) the system is operable to communicate the search target to a database searching arrangement for searching the one or more databases to generate search results corresponding to the search target;
(iv) the system is operable to process the search results to distribute them to their respective one or more categories, and then to present the one or more categories in corresponding one or more spatial regions of one or more display devices providing the user interface (UI), wherein the one or more search results are presented as one or more graphical objects organized within the one or more spatial regions of the user interface (UI); and
(v) the system is operable to provide on the user interface (UI) supplementary information describing in greater detail the one or more search results in response to user-interrogation of the one or more graphical objects.

2. The data processing system as claimed in claim 1, wherein the system is operable present the one or more search results in manner which is progressively more detailed from substantially a first edge of the user interface (UI) to substantially a second edge of the user interface (UI), wherein the first and second edges are mutually opposite edges of the user interface (UI).

3. The data processing system as claimed in claim 1, wherein the system is operable present the one or more search results in a manner which is progressively more detailed from substantially a first edge of the user interface (UI) to substantially a second edge of the user interface (UI), wherein the first and second edges are:
(i) mutually opposite bottom and top edges of the user interface (UI); or
(ii) mutually adjacent edges of the user interface (UI).

4. The data processing system as claimed in claim 1, wherein the system is operable present the one or more search results in manner which is progressively more detailed from substantially a centre of the user interface (UI) to substantially a peripheral edge of the user interface (UI), in a manner which becomes progressively more details from the centre to the peripheral edge of the user interface (UI).

5. The data processing system as claimed in claim 1, wherein the system is operable to collect metadata from the one or more databases corresponding to the one or more search results, wherein the metadata is employed to generate the supplementary information.

6. The data processing system as claimed in claim 1, wherein the one or more search results correspond to one or more e-commerce products.

7. The data processing system as claimed in claim 1, wherein the one or more search results are scrollable along at least one of the one or more regions of the user interface (UI).

8. The data processing system as claimed in claim 1, wherein the one or more search results are presented as one or more graphical objects organized within an n-dimensional matrix on the user interface (UI), wherein n is an integer having a value of unity or greater.

9. The data processing system as claimed in claim 1, wherein the one or more search results are presented as one or more thumbnail graphical images on the user interface (UI).

10. The data processing system as claimed in claim 1, wherein the one or more categories correspond to one or more data types stored in the one or more databases.

11. The data processing system as claimed in claim 10, wherein the one or more categories correspond to one or more encoding standards employed to generate data represented by the one or more search results, wherein the one or more encoding standards include at least one of: documents, images, videos, multimedia content, audio content, e-book.

12. The data processing system as claimed in claim 1, wherein the one or more regions of the user interface (UI) are dynamically reconfigurable in size and/or position within the graphical interface in response to user-interrogation of the one or more search results presented on the user interface (UI).

13. The data processing system as claimed in claim 1, wherein the user interface (UI) is implemented by using one or more touch-sensitive graphical display devices.

14. The data processing system as claimed in claim 1, wherein one or more display devices employed to implement the user interface (UI) are coupled to the one or more database via a wireless communication network.

15. A method of using a data processing system for searching information recorded in one or more databases and for generating one or more corresponding search results for presentation via a user interface (UI) in a manner which reduces an overall computational effort at the one or more databases and reduces an amount of data exchange between the one or more databases and the user interface (UI), wherein the system includes computing hardware which is operable to execute one or more software products recorded on machine-readable data storage media, wherein the method includes:
(i) Operating the system to enable a user to define, via the user interface (UI), one or more categories into which search results are to be sorted after analysis thereof;
(ii) Operating the system to receive one or more search terms input by the user via the user interface (UI), and to process the one or more search terms to include information indicative of the one or more categories to generate a corresponding search target;
(iii) Operating the system to communicate the search target to a database searching arrangement for searching the one or more databases to generate search results corresponding to the search target;
(iv) Operating the system to process the search results to distribute them to their respective one or more categories, and then to present the one or more categories in corresponding one or more spatial regions of one or more display devices providing the user interface (UI), wherein the one or more search results are presented as one or more graphical objects organized within the one or more spatial regions of the user interface (UI); and
(v) Operating the system to provide on the user interface (UI) supplementary information describing in greater detail the one or more search results in response to user-interrogation of the one or more graphical objects representative of the one or more search results.

16. The method of claim 15, wherein the method includes operating the system to collect metadata from the one or more databases corresponding to the one or more search results, wherein the metadata is employed to generate the supplementary information.

17. The method as claimed in claim 15, wherein the method includes operating the system to process one or more search results corresponding to one or more e-commerce products.

18. The method as claimed in claim 15, wherein the method includes operating the system to present the one or more search results in a scrollable manner along at least one of the one or more regions of the user interface (UI).

19. The method as claimed in claim 15, wherein the method includes operating the system to present the one or more search results as one or more graphical objects organized within an n-dimensional matrix on the user interface (UI), wherein n is an integer having a value of unity or greater.

20. The method as claimed in claim 15, wherein the method includes presenting the one or more search results as one or more thumbnail graphical images on the user interface (U I).

21. The method as claimed in claim 15, wherein the method includes operating the system to cause the one or more categories to correspond to one or more data types stored in the one or more databases.

22. The method as claimed in claim 19, wherein the one or more categories correspond to one or more encoding standards employed to generate data represented by the one or more search results, wherein the one or more encoding standards include at least one of: documents, images, videos, multimedia content, audio content, e-book.

23. The method as claimed in claim 15, wherein the method includes operating the system for generating the one or more regions of the user interface (UI) in dynamically reconfigurable manner in respect of size and/or position within the graphical interface in response to user-interrogation of the one or more search results presented on the user interface (UI).

24. The method as claimed in claim 15, wherein the method includes implementing the user interface (UI) by using one or more touch-sensitive graphical display devices.

25. The method as claimed in claim 15, wherein one or more display devices employed to implement the user interface (UI) are coupled to the one or more database via a wireless communication network.

26. A software product recorded on non-transitory machine-readable data storage media, wherein the software product is executable upon computing hardware for implementing the method as claimed in claim 15.

27. The software product as claimed in claim 26, wherein the software product is implemented to provide a search browser.

28. The software product as claimed in claim 25, wherein the search browser is adapted for providing at least one of: Internet searching, library facility searching.
